(19) United States
(12) Patent Application Publication
(10) Pub. No.: US 2015/0206631 A1
(43) Pub. Date: Jul. 23, 2015

(54) Anisotropic Bonded Magnets

(71) Applicant: Board of Regents, The University of Texas System, Austin, TX (US)

(72) Inventor: J. Ping Liu, Colleyville, TX (US)

(21) Appl. No.: 14/418,759

(22) PCT Filed: Aug. 3, 2013
(86) PCT No.: PCT/US2013/053529

§ 371 Date: Jan. 30, 2015

Related U.S. Application Data
(60) Provisional application No. 61/679,409, filed on Aug. 3, 2012.

(51) Int. Cl. H01F 1/057; H01F 41/02; B22F 3/02; H01F 1/055

(52) U.S. Cl. CPC H01F 1/0578; H01F 1/0558; H01F 41/0266; B22F 3/02

(57) ABSTRACT

The present invention provides an anisotropic bonded magnet and a method for fabricating the anisotropic bonded magnet by producing anisotropic chips by ball milling a rare-earth polycrystalline material with a surfactant in presence of a first magnetic field, mixing the anisotropic chips with one or more binding agents, and forming the anisotropic bonded magnet by compacting the mixture of anisotropic chips and binding agents in presence of a second magnetic field.

### STATEMENT OF FEDERALLY SPONSORED RESEARCH OR DEVELOPMENT

This invention was made with government support under Grant No. W911NF-08-1-0249 awarded by the U.S. Department of Defense/Defense Advanced Research Projects Agency/Army Research Office. The U.S. government has certain rights in the invention.

### FIELD OF INVENTION

The present invention relates generally to the field of magnets and, more particularly, to anisotropic bonded magnets fabricated by surfactant-assisted ball milling and magnetic-field processing.

### BACKGROUND ART

Improved permanent magnets are essential for emergent applications in electronic and electric devices [1-3]. While sintered permanent magnets are still the major type magnets for most applications, demand for bonded magnets is rapidly growing for the advantages of bonded magnets in part size and shape control which is particularly important for miniaturization of electronic devices [4]. However, there is a major disadvantage of bonded magnets: their energy density is substantially lower than sintered magnets, due to diluted magnetic components and the isotropic nature. Most rare-earth bonded magnets are isotropic because the magnetic powders used for producing bonded magnets are isotropic. Though attempts have been made to produce anisotropic bonded rare-earth magnets based on Nd—Fe—B and Sm—Fe—N micron-sized powder particles [5-8] production of nanoscale anisotropic rare-earth magnetic powder particles remains a significant challenge.

Surfactant-assisted ball-milling has been proven to be an effective technique to produce anisotropic hard magnetic nanoparticles including Sm—Co and Nd—Fe—B based rare-earth nanocrystalline materials [9-13]. The produced Sm—Co and Nd—Fe—B nanoparticles containing fine grains have high aspect ratio with their thickness of tens of nanometers and width and length of several hundred nanometers. The chip-like nanocrystals show strong magnetocrystalline anisotropy and can be aligned in a magnetic field.

### SUMMARY OF THE INVENTION

The present invention provides a product and process from fabricating anisotropic bonded magnets by surfactant-assisted ball milling in a magnetic field and magnetic field alignment of the milled chip-like nanoparticles of the Sm—Co and Nd—Fe—B materials. The application of magnetic fields during the ball milling strengthens the anisotropy of the chips and therefore improves the alignment. This combined technique opens a new approach to fabrication of anisotropic bounded magnets for various applications.

More specifically, the present invention provides a method for fabricating an anisotropic bonded magnet by producing anisotropic chips by ball milling a rare-earth polycrystalline material with a surfactant in presence of a first magnetic field, mixing the anisotropic chips with one or more binding agents, and forming the anisotropic bonded magnet by compacting the mixture of anisotropic chips and binding agents in presence of a second magnetic field.

In addition, the present invention provides an anisotropic bonded magnet fabricated by producing anisotropic chips by ball milling a rare-earth polycrystalline material with a surfactant in presence of a first magnetic field, mixing the anisotropic chips with one or more binding agents, and forming the anisotropic bonded magnet by compacting the mixture of anisotropic chips and binding agents in presence of a second magnetic field.

Moreover, the present invention provides a method for fabricating an anisotropic bonded magnet by producing anisotropic chips by ball milling a SmCo₅, Sm₂Co₇ or Nd₂Fe₁₄B material with oleic acid having a purity of at least 90% and heptane having a purity of at least 99% in presence of a first magnetic field having a first H-field value of at least 1 to 3 kOe, wherein the oleic acid is 50% by weight of the SmCo₅, Sm₂Co₇ or Nd₂Fe₁₄B material. The anisotropic chips are then mixed with phenylene sulfide (PPS), and the anisotropic bonded magnet is formed by compacting the mixture of anisotropic chips and epoxy or polymer in presence of a second magnetic field having a second H-field value of at least 20 kOe.

Furthermore, the present invention provides an anisotropic bonded magnet fabricated by producing anisotropic chips by ball milling a SmCo₅, Sm₂Co₇ or Nd₂Fe₁₄B material with oleic acid having a purity of at least 90% and heptane having a purity of at least 99% in presence of a first magnetic field having a first H-field value of at least 1 to 3 kOe, wherein the oleic acid is 50% by weight of the SmCo₅, Sm₂Co₇ or Nd₂Fe₁₄B material, mixing the anisotropic chips with phenylene sulfide (PPS), and forming the anisotropic bonded magnet by compacting the mixture of anisotropic chips and epoxy or polymer in presence of a second magnetic field having a second H-field value of at least 20 kOe.

The present invention is described in detail below with reference to the accompanying drawings.

### BRIEF DESCRIPTION OF THE DRAWINGS

Further benefits and advantages of the present invention will become more apparent from the following description of various embodiments that are given by way of example with reference to the accompanying drawings:

FIG. 1 is a flow chart of a method for fabricating an anisotropic bonded magnet in accordance with one embodiment of the present invention;

FIG. 2 is a flow chart of a method for fabricating an anisotropic bonded magnet in accordance with one embodiment of the present invention;

FIGS. 3A-3C show XRD patterns of (A) SmCo₅, (B) Sm₂Co₇ and (C) Nd₂Fe₁₄B chips randomly oriented and aligned in magnetic field (insets show SEM images of the chip-like nanoparticles) in accordance with one embodiment of the present invention;

FIGS. 3D-3F show the demagnetization curves of the aligned samples measured in the directions parallel and perpendicular to the easy direction (alignment direction) for the SmCo₅, Sm₂Co₇ and Nd₂Fe₁₄B samples, respectively in accordance with one embodiment of the present invention;

FIGS. 4A-4C show the remanence ratio of demagnetization curves measured in alignment direction (easy magnetization direction) of aligned chips milled in a magnetic field and without field for different milling time verses grain size for (A) SmCo₅, (B) Sm₂Co₇ and (C) Nd₂Fe₁₄B in accordance with one embodiment of the present invention;

FIGS. 4D-4F show the dependence of the average misalignment angle on the grain size of the corresponding samples in accordance with one embodiment of the present invention;

FIGS. 5A-5B shows (002) pole figures of aligned SmCo₅ chips assemblies (A) particles milled without field for 1 hr, (B) particles milled in a magnetic field in accordance with one embodiment of the present invention; and

FIGS. 6A-DB show SEM images of SmCo₅ chips (A and B) milled without a magnetic field and (C and D) milled in a magnetic field in accordance with one embodiment of the present invention.

### DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

To further enhance the magnetic anisotropy of the nanoparticles, the present invention provides a fabrication method in which a magnetic field is applied during surfactant-assisted ball-milling. The anisotropic nanoscale chips are then processed into bonded magnets by mixing binder materials with the powders and pressing the mixtures in a magnetic field. The description below demonstrates the anisotropic magnetic properties of the bonded magnets fabricated by methods of the present invention. Moreover, the effect of external magnetic fields during ball milling on the magnetic properties will be discussed in detail.

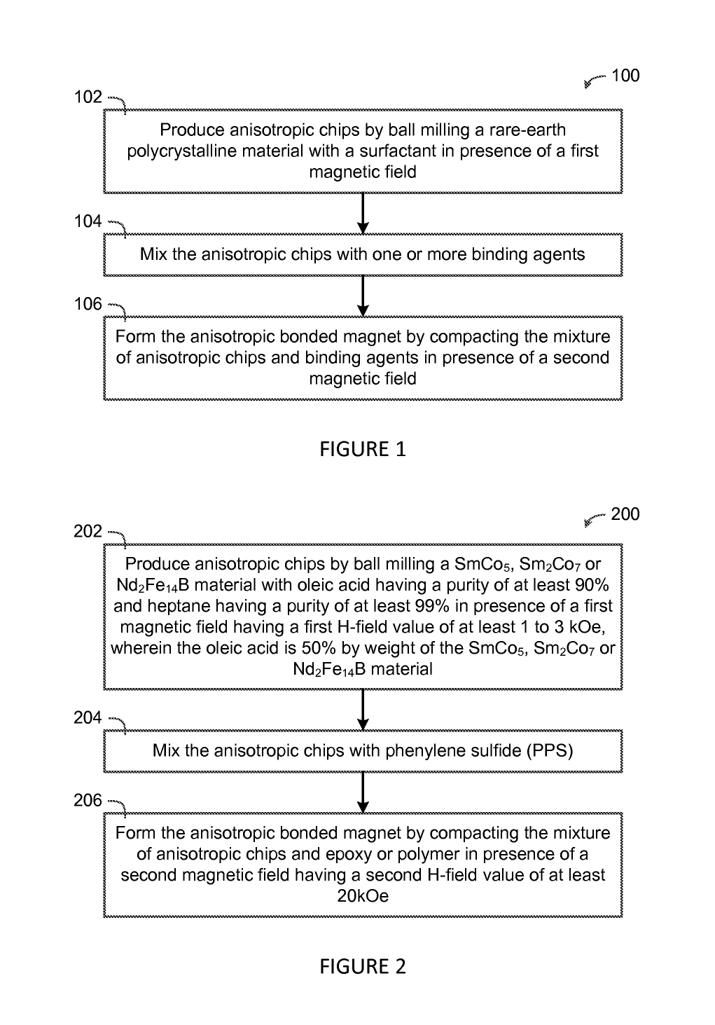

Now referring to FIG. 1, a flow chart of a method 100 for fabricating an anisotropic bonded magnet in accordance with one embodiment of the present invention is shown. Anisotropic chips are produced by ball milling a rare-earth polycrystalline material (e.g., SmCo₅, Sm₂Co₇, Nd₂Fe₁₄B, etc.) with a surfactant (e.g., oleic acid, oleyl amine, a combination thereof, etc.) in presence of a first magnetic field in block 102. The anisotropic chips are mixed with one or more binding agents (e.g., epoxy, polymer, etc.) in block 104. The anisotropic bonded magnet is formed by compacting the mixture of anisotropic chips and binding agents in presence of a second magnetic field in block 106.

The oleic acid can have a purity of at least 90%. Moreover, the oleic acid can be 50% by weight of the rare-earth polycrystalline material. A phenylene sulfide (PPS) can be used as the binding agent. The first magnetic field can have a first H-field value of at least 1 to 3 kOe and the second magnetic field can have a second H-field value of at least 20 kOe. The first magnetic field and the second magnetic field can have a B-field value of at least 15 to 20 kG. The ball milling process can take between 10 minutes to 20 hours. The first magnetic field and the second magnetic field are produced by two diametrically oriented arc-segment permanent magnets fixed around a non-metallic vessel (e.g., stainless steel, etc.). As will be appreciated by those skilled in the art, the rare-earth polycrystalline materials, binding agents, magnetic field values, processing times and other components and variables described herein are merely representative examples and can be changed and/or modified depending on the characteristics and properties that are desired in the resulting magnet.

In addition, a solvent (e.g., heptane, xylene, etc.) can be used with the rare-earth polycrystalline material in addition to the surfactant. The method can also include the steps of curing the compacted mixture of anisotropic chips and binding agents, or removing one or more fine particles from the anisotropic chips. For example, the fine particles can be removed by subjecting the anisotropic chips to an ultrasonic vibration, washing the anisotropic chips, and centrifuging the anisotropic chips. The anisotropic chips can be washed with a solution comprising heptane. Moreover, the step of mixing the anisotropic chips with the one or more binding agents is performed within the first magnetic field or the second magnetic field or a third magnetic field. Note that the magnetic fields can be the same throughout the process.

In some embodiments of the present invention, the anisotropic chips have an energy product greater than or equal to 24 MGOe and a remanence of greater than equal to 0.92 Tesla. The anisotropic bonded magnet can have an energy product greater than 13 MGOe with a density of greater than 6.5 g/cm³.

As a result, the present invention provides an anisotropic bonded magnet fabricated by producing anisotropic chips by ball milling a rare-earth polycrystalline material with a surfactant in presence of a first magnetic field, mixing the anisotropic chips with one or more binding agents, and forming the anisotropic bonded magnet by compacting the mixture of anisotropic chips and binding agents in presence of a second magnetic field.

Referring now to FIG. 2, a flow chart of a method 200 for fabricating an anisotropic bonded magnet in accordance with one embodiment of the present invention is shown. Anisotropic chips are produced by ball milling a SmCo₅, Sm₂Co₇ or Nd₂Fe₁₄B material with oleic acid having a purity of at least 90% and heptane having a purity of at least 99% in presence of a first magnetic field having a first H-field value of at least 1 to 3 kOe in block 202. The oleic acid is 50% by weight of the SmCo₅, Sm₂Co₇ or Nd₂Fe₁₄B material. The anisotropic chips are then mixed with phenylene sulfide (PPS) in block 204. The anisotropic bonded magnet is formed by compacting the mixture of anisotropic chips and epoxy or polymer in presence of a second magnetic field having a second H-field value of at least 20 kOe in block 206.

As a result, the present invention provides an anisotropic bonded magnet fabricated by producing anisotropic chips by ball milling a SmCo₅, Sm₂Co₇ or Nd₂Fe₁₄B material with oleic acid having a purity of at least 90% and heptane having a purity of at least 99% in presence of a first magnetic field having a first H-field value of at least 1 to 3 kOe, wherein the oleic acid is 50% by weight of the SmCo₅, Sm₂Co₇ or Nd₂Fe₁₄B material, mixing the anisotropic chips with phenylene sulfide (PPS), and forming the anisotropic bonded magnet by compacting the mixture of anisotropic chips and epoxy or polymer in presence of a second magnetic field having a second H-field value of at least 20 kOe.

In one example of the present invention, the starting commercial SmCo₅, Sm₂Co₇ and Nd₂Fe₁₄B powders of particle size ˜45 μm were mixed with organic solvent heptane of 99.8% purity and surfactant oleic acid of 90% purity. In a typical milling load, powder to ball weight ratio of 1:10 was used in a nonmagnetic stainless steel vial. The amount of surfactant used was 50% by weight of the starting powders. Two diametrically oriented arc-segment permanent magnets were fixed around a nonmagnetic stainless steel vial to create a quasi-homogeneous magnetic field of about 1-3 kOe. The mixtures were then milled using a high-energy ball milling machine from 10 minutes to 20 hours. For comparison, the starting powders were also milled without magnetic field while keeping other milling parameters unchanged. A size selection process was employed after the milling process to remove fine particles by ultrasonic vibration and washing final products several times with heptane followed by centrifugal process [10-12]. To characterize the anisotropic magnetic properties, nanoscale chips were mixed with epoxy and aligned in a magnetic field of 20 kOe. Bonded magnets were made by mixing as-milled nanoparticles with organic binders and pressing the mixture under a magnetic field of about 16 kG. Magnetic properties were measured by a superconducting interference device magnetometer with a maximum applied field of 70 kOe. Structural and morphological characterizations were performed using x-ray diffraction (XRD) (Rigaku Ultima IV diffractometer operating with CuKα radiation) and scanning electron microscope (SEM). Measurement of (002) pole figures were carried out by the Schulz's reflection method. The tilt angle (α) was varied from 0° to 70° in steps of 2.5°. The angle of rotation, azimuth angle (β) was varied from 0° to 360° in steps of 5°.

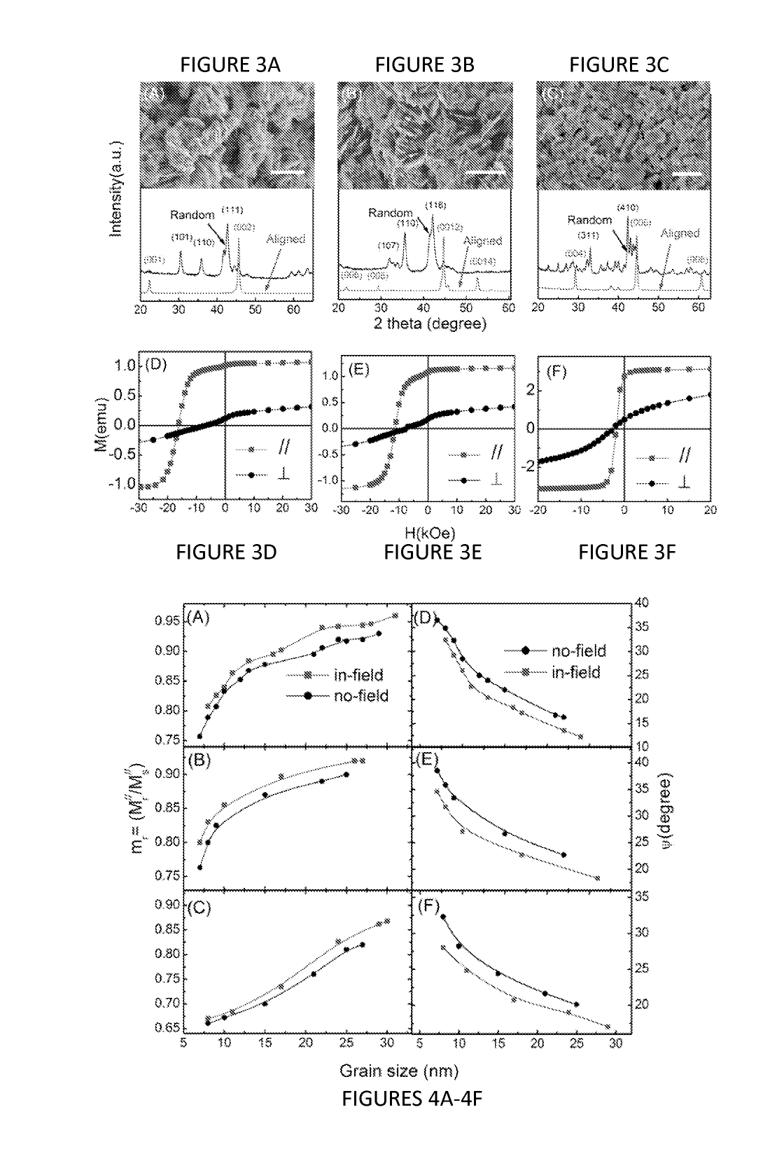

Now referring to FIGS. 3A-3C, typical XRD patterns of the aligned and randomly oriented SmCo₅, Sm₂Co₇ and Nd₂Fe₁₄B nanoparticles in epoxy are shown. The insets are typical SEM images of the as-prepared nanoscale chip-like particles prepared by surfactant-assisted ball milling for 1 hour. The alignment field was 20 kG. Compared to the randomly oriented samples, the intensities of (002) of SmCo₅, (0012) of Sm₂Co₇ and (006) of Nd₂Fe₁₄B diffraction peaks of the aligned samples are enhanced significantly, while other peaks largely disappear, suggesting a (001) out-of-plane alignment (along c-axis). FIGS. 3D-3F show demagnetization curves of the corresponding samples. The demagnetization curves with substantial difference in two directions confirm the strong anisotropy resulted from the grain alignment in c-axis in the SmCo₅, Sm₂Co₇ and Nd₂Fe₁₄B nanoscale chips.

To further enhance the magnetic anisotropy, an external magnetic field was applied during the ball milling process. Previous investigations [14, 15] revealed that external magnetic fields enhance magnetic anisotropy in polycrystalline particles prepared by ball milling. The magnetic fields, however, reduced the milling efficiency simultaneously, as seen from the grain size reduction for samples milled for same time. Therefore, it is more reasonable to compare the anisotropy of samples with same grain size (instead of same milling time). FIGS. 4A-4F show the external magnetic field effect on magnetic anisotropy of SmCo₅, Sm₂Co₇ and Nd₂Fe₁₄B nanoparticle during ball milling, with milling time from 10 minutes to 20 hrs. The anisotropy was measured by the remanence ratio mᵣ=(Mᵣ^{//}/Mₛ^{//}) the remanence along the aligned direction (c-axis). The average grain size was calculated by using Scherrer formula. FIGS. 4A-4C show the dependence of the remanence ratio on the grain size of the aligned SmCo₅, Sm₂Co₇ and Nd₂Fe₁₄B nanoparticle assemblies with the particles prepared in a magnetic field and without magnetic field, respectively. It is striking to observe that the remanence for the field-milled samples is always higher than for those milled without the field. The increase in the remanence upon field milling is in the range from 3 to 6% (measured in the easy magnetization direction).

Degree of alignment of chips can also be calculated by the average misalignment angle ψ=arctan [2Mr (⊥)/Mr (//)], where Mr (⊥) and Mr (//) are the remanences perpendicular and parallel to the direction of the easy axis [16]. FIGS. 4D-4F show the dependence of the misalignment angle on the grain size of the chips milled in a magnetic field and without field. It was found that the misalignment angle (ψ) of the chips milled in the presence of a magnetic field is smaller than that of the milled without field, which further confirms that the degree of alignment of the chips milled in the presence of a magnetic field is higher than that of the chips milled in absence of a magnetic field for same grain size.

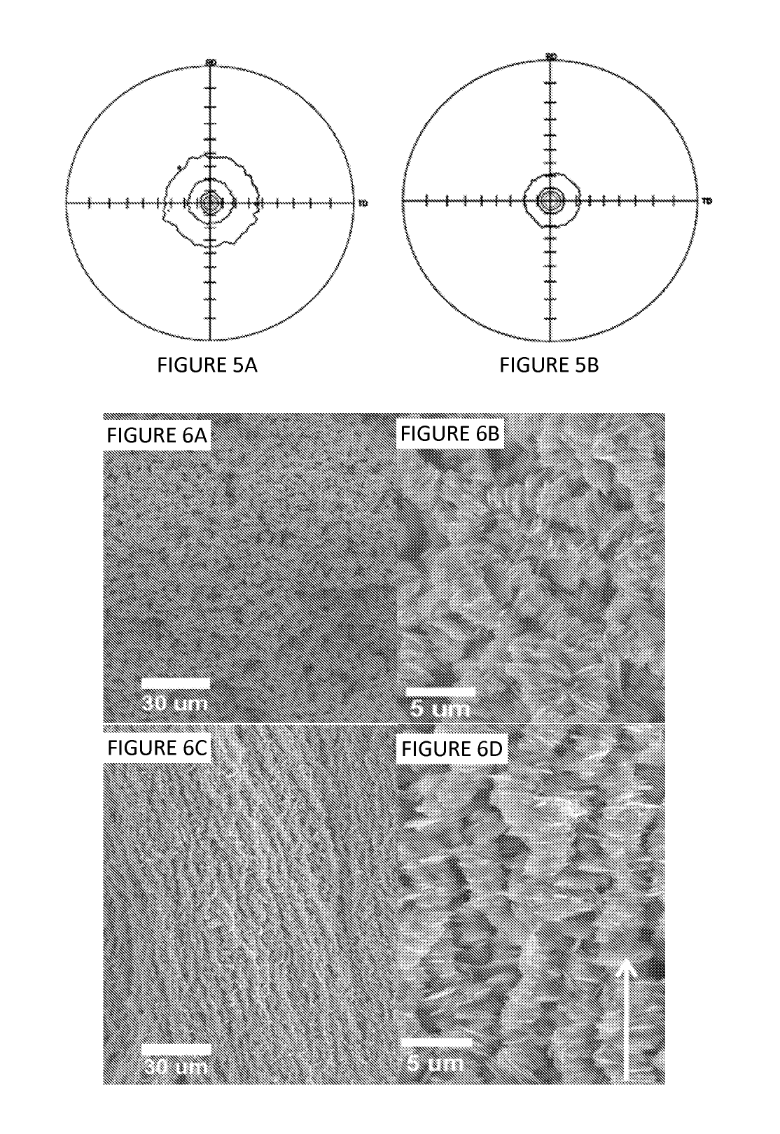

Referring now to FIG. 5A-5B, a two-dimensional (002) pole figures for the aligned SmCo₅ nanoscale chips of (A) particles were milled without a magnetic field (B) particles were milled in a field for 1 hr are shown. These two samples have their misalignment angle (ψ) of 17° and 13°, respectively. The contour lines, which correspond to changes in the intensity of the (002) diffraction lines are more concentrated in the center of axis for the magnet with higher degree of alignment [17]. FIG. 5B shows the contour lines with well defined circular pattern while in FIG. 5A, some broadening of the contour lines occurred without degradation of the patterns. On comparison of pole figures for the nanoparticles milled in a magnetic field and without magnetic field prepared under same processing condition gives direct evidence that nanoparticles milled in a magnetic field have higher degree of alignment compared to the nanoparticles samples milled without field. It should be noted that the degree of grain alignment decreases with decreasing grain size due to the fact that smaller grains incline to randomly orient and incoherence in grain boundaries reduces the alignment.

Morphology of SmCo and NdFeB chips obtained by surfactant-assisted ball milling in a magnetic field and in absence of magnetic field for different milling time was monitored by SEM. FIGS. 6A-6D show the typical SEM images of SmCo₅ chips fabricated by surfactant-assisted ball milling processes for 1 hr. It is can be seen from the low magnification SEM images that the SmCo₅ chips prepared in absence of the magnetic field (FIG. 6A) are randomly oriented while the SmCo₅ chips prepared in the magnetic field formed a chain-like structure (FIG. 6C). FIG. 6B shows the SEM image of SmCo₅ chips with high-aspect ratio obtained after 1 hour milling in absence of magnetic field with diameter in the range of 5 to 8 μm and thickness in the range of 20 to 120 nm (determined by HRSEM analysis, not shown here). FIG. 6D shows the SEM image of the SmCo₅ chips obtained after 1 hour milling in a magnetic field. The arrow in FIG. 6D indicates the alignment direction caused by the magnetic field. Analysis of SEM images shows that there is no considerable difference in size of the chips prepared in a magnetic field compared to those obtained without magnetic field. It was found that the chip size reduces with extending the milling, in both the field-ball milling and non-field-ball milling. For example, the average diameter of SmCo₅ chips of both field-ball milled and non-field-ball milled decreased from 6 μm to 3 μm when milling time was extended from 1 hr to 20 hrs. It is important to point out that the particle size is not equal to the grain size. The grain size, starting with original particle size of tens of micrometers, reduces to nanometric order with milling. It is observed from the SEM images of SmCo₅ chips milled in a magnetic field (FIG. 6D) that chips are oriented and formed a chain-like structure stacking with their surfaces perpendicular to the direction of magnetic field (magnetic field direction is shown by an arrow). It should be noted that analysis of orientation of SmCo₅ chips from SEM images (FIG. 6D) milled in a magnetic field and from XRD patterns of aligned samples (FIGS. 3A-3F), it is confirmed that c-axis is perpendicular to the plan of the SmCo₅ chips. It should also be noted that despite the nanocrystalline nature of the chips, out-of-plane (001) texture is maintained in polynanocrystalline chips inherited from single crystal starting powders [18].

As a result of the enhanced magnetic anisotropy, remarkably higher energy product values are obtained for SmCo₅ nanoscale chips milled under magnetic field compared to those without magnetic field in same milling conditions. For example, higher energy products up to 26.0 MGOe has been obtained for SmCo₅ nanoparticles prepared in magnetic field, compared to 23.5 MGOe of that without magnetic field (with the remanence of 0.96 and 0.91, respectively). The higher energy product in a field milled chips samples results from enhanced remanence and better squareness of the demagnetization curves compared to the nanoparticles milled without field. The difference of magnetic properties is also an evidence for enhanced anisotropy. Based on the anisotropic chips, it is possible to fabricate anisotropic bulk magnets by compaction of the chips in the presence of a magnetic field. The magnetic field aligns the chips during which the compaction consolidates the aligned flakes. The energy product above 13 MGOe with real density 6.5 g/cm³ has been obtained for the bonded magnets prepared by SmCo₅ chips milled in presence of a magnetic field and compacted under the magnetic field using PPS as binder.

Based on the experimental results including SEM images, XRD patterns (including pole figures) and magnetic properties, mechanisms for better alignment of the SmCo₅, Sm₂Co₇ and Nd₂Fe₁₄B nanoscale chips milled in the magnetic field will now be described. When the milling process is carried out in a magnetic field, the chips are magnetized and formed chains with their surfaces perpendicular to magnetic field direction as seen in FIG. 6B. The chips in the chains are aligned to minimize the system energy. The c-axis of the chips is found to be in the direction of the magnetic field. Without a magnetic field, the chains did not form. The improved alignment of the chips milled in a magnetic field compared to the chips milled without a field is obviously associated to the better orientation of each chip with its c-axis to the chain-axis direction (perpendicular to the chip plane in case for Sm-Co chips) which contributes to the enhanced magnetic anisotropy. The enhancement may also be related to the effect of magnetic field on the gain orientation during the cold welding process during ball milling process. Note that the mechanisms for different materials may be different.

In summary, anisotropic bonded magnets have been successfully fabricated by using the surfactant-assisted ball milling and magnetic field processing during the milling and aligning procedures. The structural and magnetic characterizations revealed that the hard magnetic SmCo and NdFeB chips obtained by surfactant-assisted milling in a magnetic field exhibit enhanced magnetic anisotropy compared to those milled without a magnetic field. A higher energy product up to 26 MGOe has been obtained for SmCo₅ chips prepared in magnetic field compared to 23 MGOe without magnetic field with remanence of 0.96 and 0.91. The energy product above 13 MGOe has been obtained for anisotropic bonded magnets with density of 6.5 g/cm³ compacted in presence of a magnetic field. This combined technique shows promise for producing novel nanostructured anisotropic bulk magnets with enhanced magnetic properties.

### REFERENCES

[1] Crescimbini F, Napoli A D, Solero L and Caricchi F (2005) IEEE Trans. Ind. Appl. 41 1168.
[2] Baroudi J A, Dinavahi V, Knight A M (2007) Renewable Energy 32 2369.
[3] Goll D, Kronmüller H (2000) Naturwissenschaften 87 423.
[4] Croat J J (1997) J. Appl. Phys. 81 4804.
[5] Hamada N, Mishima C, Mitarai H, and Honkura Y (2003) IEEE Trans. Magn. 39 2953.
[6] Hamada N, Noguchi K, Mishima C, and Honkura Y (2005) IEEE Trans. Magn. 41 3847
[7] Yamashita F, Kawamura K, Okada Y, Murakami H, Ogushi M, Nakano M and Fukunaga H (2007) J. Magn. Magn. Mater. 316 e101.
[8] Yamashita F, Ogushi M Nakano M, Fukunaga H, (2007) J. Magn. Magn. Mater. 310 2578.
[9] Chakka V M, Altuncevahir B, Jin Z Q, Li, and Liu J P J. Appl. Phys. (2006) 99 08E912.
[10] Wang Y P, Li Y, Rong C B, and Liu J P Nanotechnology (2007) 18 465701.
[11] Poudyal N, Rong C B and Liu J P (2010) J. Appl. Phys., 107 09A703.
[12] Poudyal N, Rong C B and Liu J P (2010) REPM 10-Proceedings of the 21st Workshop on Rare-Earth Permanent Magnets and their Applications (Bled: Slovenia) p 120.
[13] Cui B Z, Gabay A M, Li W F, Marinescu M, Liu J F, and Hadjipanayis G C (2010) J. Appl. Phys. 107 09A721.
[14] Poudyal N, Altuncevahir B, Chakka V, Chen K, Black T D, Liu J P, Ding Y, Wang Z L (2004) J. Phys. D: Appl. Phys. 37, L45.
[15] Rong C B, Nguyen V N, and Liu J P (2010) J. Appl. Phys. 107 09A717.
[16] Fernengel W, Lehnert A, Katter M, Rodewald W, and Wall B (1996) J. Magn. Magn. Mater. 157-158 19.
[17] Castro A R M, Galego E, Lima N B, Faria R N (2004) J. Magn. Magn. Mater. 278 39.
[18] Cui B Z, Li W F, Hadjipanayis G C (2011) Acta Meterialia 59 563.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification, but only by the claims.

1. A method for fabricating an anisotropic bonded magnet comprising the steps of:
producing anisotropic chips by ball milling a rare-earth polycrystalline material with a surfactant in presence of a first magnetic field;
mixing the anisotropic chips with one or more binding agents; and
forming the anisotropic bonded magnet by compacting the mixture of anisotropic chips and binding agents in presence of a second magnetic field.

2. The method as recited in claim 1, wherein the rare-earth polycrystalline material comprises SmCo₅, Sm₂Co₇ or Nd₂Fe₁₄B.

3. The method as recited in claim 1, wherein the surfactant comprises oleic acid, oleyl amine or a combination thereof.

4. The method as recited in claim 1, wherein the surfactant comprises oleic acid having a purity of at least 90%.

5. The method as recited in claim 4, wherein the oleic acid is 50% by weight of the rare-earth polycrystalline material.

6. The method as recited in claim 1, wherein the one or more binding agents comprise an epoxy or a polymer.

7. The method as recited in claim 6, wherein the polymer comprises phenylene sulfide (PPS).

8. The method as recited in claim 1, wherein the first magnetic field has a first H-field value of at least 1 to 3 kOe and the second magnetic field has a second H-field value of at least 20 kOe.

9. The method as recited in claim 1, wherein the first magnetic field and the second magnetic field have a B-field value of at least 15 to 20 kG.

10. The method as recited in claim 1, further comprising the step of producing the first magnetic field and the second magnetic field using by two diametrically oriented arc-segment permanent magnets fixed around a non-metallic vessel.

11. The method as recited in claim 1, wherein the step of producing the anisotropic chips is performed for a period of 10 minutes to 20 hours.

12. The method as recited in claim 1, wherein a solvent is used with the rare-earth polycrystalline material in addition to the surfactant.

13. The method as recited in claim 12, wherein the solvent comprises heptane or xylene.

14. The method as recited in claim 12, wherein the solvent comprises heptane having a purity of at least 99%.

15. The method as recited in claim 1, further comprising the step of curing the compacted mixture of anisotropic chips and binding agents.

16. The method as recited in claim 1, further comprising the step of removing one or more fine particles from the anisotropic chips.

17. The method as recited in claim 1, further comprising the steps of:
subjecting the anisotropic chips to an ultrasonic vibration;
washing the anisotropic chips; and
centrifuging the anisotropic chips.

18. The method as recited in claim 17, wherein the anisotropic chips are washed with a solution comprising heptane.

19. The method as recited in claim 1, wherein the step of mixing the anisotropic chips with the one or more binding agents is performed within the first magnetic field or the second magnetic field or a third magnetic field.

20. The method as recited in claim 1, wherein the first magnetic field is the same as the second magnetic field.

21. The method as recited in claim 1, wherein the anisotropic chips have an energy product greater than or equal to 24 MGOe and a remanence of greater than equal to 0.92 Tesla.

22. The method as recited in claim 1, wherein the anisotropic bonded magnet has an energy product greater than 13 MGOe with a density of greater than 6.5 g/cm³.

23. An anisotropic bonded magnet fabricated by producing anisotropic chips by ball milling a rare-earth polycrystalline material with a surfactant in presence of a first magnetic field, mixing the anisotropic chips with one or more binding agents, and forming the anisotropic bonded magnet by compacting the mixture of anisotropic chips and binding agents in presence of a second magnetic field.

24-44. (canceled)

45. A method for fabricating an anisotropic bonded magnet comprising the steps of:
producing anisotropic chips by ball milling a SmCo₅, Sm₂Co₇ or Nd₂Fe₁₄B material with oleic acid having a purity of at least 90% and heptane having a purity of at least 99% in presence of a first magnetic field having a first H-field value of at least 1 to 3 kOe, wherein the oleic acid is 50% by weight of the SmCo₅, Sm₂Co₇ or Nd₂Fe₁₄B material;
mixing the anisotropic chips with phenylene sulfide (PPS); and
forming the anisotropic bonded magnet by compacting the mixture of anisotropic chips and epoxy or polymer in presence of a second magnetic field having a second H-field value of at least 20 kOe.

46-56. (canceled)

57. An anisotropic bonded magnet fabricated by producing anisotropic chips by ball milling a SmCo₅, Sm₂Co₇ or Nd₂Fe₁₄B material with oleic acid having a purity of at least 90% and heptane having a purity of at least 99% in presence of a first magnetic field having a first H-field value of at least 1 to 3 kOe, wherein the oleic acid is 50% by weight of the SmCo₅, Sm₂Co₇ or Nd₂Fe₁₄B material, mixing the anisotropic chips with phenylene sulfide (PPS), and forming the anisotropic bonded magnet by compacting the mixture of anisotropic chips and epoxy or polymer in presence of a second magnetic field having a second H-field value of at least 20 kOe.

58-68. (canceled)
